(19) United States
(12) Patent Application Publication
(10) Pub. No.: US 2024/0413361 A1
(43) Pub. Date: Dec. 12, 2024

(54) MOISTURE-GENERATING DEVICE FOR A FUEL CELL, AND METHOD FOR OPERATING A MOISTURE-GENERATING DEVICE

(71) Applicant: Robert Bosch GmbH, Stuttgart (DE)

(72) Inventors: Elmar Okrent, Remseck (DE); Andreas Krause, Markgröningen (DE); Frank Miller, Ilsfeld (DE)

(21) Appl. No.: 18/690,389

(22) PCT Filed: Aug. 11, 2022
(86) PCT No.: PCT/EP2022/072549

§ 371 Date: Mar. 8, 2024

(30) Foreign Application Priority Data
Sep. 9, 2021 (DE) 10 2021 209 945.9

(51) Int. Cl. H01M 8/04119; H01M 8/04746; H01M 8/04828

(52) U.S. Cl. CPC H01M 8/04126; H01M 8/04776; H01M 8/04828

(57) ABSTRACT

The present invention provides a moisture-generating device (10) for generating a moisture-enriched air flow or gas flow, said device comprising: a housing (H) having an outflow region (3), in at least sections of which a gas flow or air flow can be generated, and having a lateral inlet region (EB), and having a mixing region (MB) which extends inside the housing (H); a water injector (WI) which is located in the lateral inlet region (EB) and by means of which atomized water can be introduced into the mixing region (MB) at the specific angle, wherein, in the mixing region (MB), the gas or air can be mixed with the atomized water; a humidifying grid (BG) which is located in the mixing region (MB) and to which the water injector (WI) is aligned; and a flow generator (SZ) which is located in the housing (H) between the mixing region (MB) and the outflow region (3) and by means of which the air flow or gas flow comprising the atomized water can be delivered to the outflow region (3) and can be generated.

### BACKGROUND

The present invention relates to a moisture-generating device and a method for operating a moisture-generating device.

When using conventional fuel cell systems, a fuel gas may be supplied to the fuel cell, which may have a certain degree of moisture. For example, in known fuel cell systems, if there is limited moisture, it may be necessary to increase it and to vary a degree of moisture in the fuel gas, in particular to increase it. This is carried out by means of water atomization.

In this context, current systems may have a passive way of using water for fuel cell applications or for humidification. In so doing, the aim may be to reduce the size of such systems and to increase efficiency.

WO 2008/052578 A1 refers to a fuel cell system with an anode-side input for supplying a fuel.

### SUMMARY

The present invention relates to a moisture-generating device and a method for operating a moisture-generating device according to the disclosure.

The idea underlying the present invention is to specify a moisture-generating device and a method for operating a moisture-generating device, wherein moisture in an air flow or gas flow can be controlled and the effectiveness of the enrichment of the air flow or gas flow may be improved.

In this way, an active, more cost-effective and robust way can be found to evaporate and distribute water better and more efficiently in the air flow or gas flow. In a system to which the air flow or gas flow can be delivered, such as a fuel cell, a dry air flow or gas flow, such as an air flow with low humidity, can thus be moistened with water vapor within a module placed upstream of the system (the housing of the moisture-generating device can be shaped as a module). Advantageously, liquid water supplied from the outside within the module may be largely or completely evaporated and homogenized with the air flow or gas flow.

According to the invention, the moisture-generating device for generating a moisture-enriched air flow or gas flow comprises a housing with a main extension direction and an outflow region, wherein a gas flow or air flow can be generated at least in sections along the main extension direction, and with a lateral inlet region which extends at a certain angle to the main extension direction, and with a mixing region which extends at least partially along the main extension direction in the interior of the housing; a water injector which is arranged in the lateral inlet region and with which atomized water can be introduced into the mixing region at the predetermined angle against the main extension direction, wherein in the mixing region, the gas or the air can be mixed with the atomized water, a humidifying grid which is arranged in the mixing region and towards which the water injector is aligned, wherein the humidifying grid comprises a plurality of holes and can be wetted with and/or penetrated by the atomized water from the water injector; and a flow generator, which is arranged in the housing between the mixing region and the outflow region and with which the air flow or gas flow with the atomized water can be delivered to the outflow region and generated, wherein the generated air flow or gas flow can be generated by the flow generator and running from the humidifying grid and in the direction of the outflow area.

The moisture-generating device may accordingly enrich an air flow or gas flow with evaporated or vaporized water.

The main extension direction may be parallel to the air flow or gas flow through the housing. The outflow region may comprise a round or otherwise shaped opening at one end of the housing in the main extension direction.

The lateral inlet region and the mixing region may be located in a front third of the housing, relative to the outflow region, which may be located at a rear end of the housing, and next to each other.

The outflow region may be connected to another system, for example a fuel cell, which may require the air flow or gas flow.

The water injector may introduce water in the form of droplets, i.e., already atomized water, into the mixing region and counter to the air flow or gas flow.

The holes may be the openings between the bars.

Compared to the known prior art, the moisture-generating device may be used to optimize both the water evaporation and the mixing of the water vapor with an air flow or gas flow to be supplied to the fuel cell. A combination of numerous physical effects can be used to favor both evaporation and homogenization.

According to a preferred embodiment of the moisture-generating device, the mixing area is cylindrical and a fuel cell or a supply line of a fuel cell can be connected to the outflow area of the central mixing area.

By having a cylindrical shape, the housing may advantageously be easily installed in another system, such as in or upstream of a fuel cell system, and the gas flow or air flow may be passed through the housing more easily.

According to a preferred embodiment of the moisture-generating device, the water injector is a water atomizer by means of which water can be introduced into the mixing region in droplet form, wherein the size of the droplets can be varied.

The water atomizer can be used to select the degree of humidification of the humidifying grid and/or to supply part of the atomized water to the gas flow or air flow, as the atomized water can be introduced against the direction of flow of the gas flow or air flow.

According to a preferred embodiment of the moisture-generating device, it has a modular design.

Thanks to its modular design, the moisture-generating device can be a water treatment module, for example for fuel cells.

This may be usable, with or in a valve for metering water/water mixtures such as in a gas valve.

According to a preferred embodiment of the moisture-generating device, a cylindrical cross-section of the housing tapers in a region of the flow generator and the flow generator comprises a stator with a rotor, or a turbine or a blower.

A gradient of the gas flow or air flow can be influenced by a taper, which can also influence the mixing of the gas flow or air flow and the water droplets and increase the degree of evaporation and mixing at higher velocities.

According to a preferred embodiment of the moisture-generating device, this comprises a control device which is connected to the water injector and to the flow generator and is set up to control the water injector and the flow generator in such a way that a gas flow or air flow can be generated at an outflow area of the mixing area according to a specification for the humidity and or strength of the gas flow or air flow.

The control device can thus control the volume of water, the droplet size and quantity, the speed of the gas flow or air flow and thus the evaporation and mixing.

According to a preferred embodiment of the moisture-generating device, the humidifying grid can be heated.

The evaporation effect can be improved by heating the humidifying grid.

According to the invention, in a method of operating a moisture-generating device for generating a moisture-enriched air flow or gas flow, a moisture-generating device according to the invention is provided; the atomized water is introduced into the mixing area with the water injector at the predetermined angle against the main extension direction; wetting and/or penetrating the humidifying grid with the atomized water from the water injector; generating a gas flow or air flow through the flow generator and extending from the humidifying grid and toward the discharge region with the flow generator, thereby mixing the gas flow or air flow with the atomized water and discharging the gas flow or air flow to the discharge region.

In accordance with a preferred embodiment of the method, a predetermined area of the humidifying grid is wetted with atomized water and the atomized water and/or droplets reliquefied on the humidifying grid are evaporated on the humidifying grid by the gas or air flow from the flow generator and/or distributed into the mixing area and are swirled and evaporated through the flow generator.

The larger the humidified area, the more evaporation can take place at the humidifying grid.

According to a preferred embodiment of the method, the gas flow or air flow downstream of the flow generator and upstream of the outflow region through a homogenizing grid and a gradient of moisture within the gas flow or air flow is homogenized at least in regions.

Homogenization may be advantageously increased, which may produce a more uniform gas flow or air flow in terms of moisture.

The moisture-generating device can also be characterized by the features mentioned in connection with the method and by the advantages of the method, and vice versa.

Further features and advantages of embodiments of the invention arise from the following description with reference to the accompanying drawings.

### BRIEF DESCRIPTION OF THE DRAWINGS

The present invention is explained in greater detail below with reference to the exemplary embodiments indicated in the schematic figures of the drawings.

The figures show:

FIG. 1 a schematic representation of a moisture-generating device according to an exemplary embodiment of the invention;

FIG. 2 a schematic representation of a flow generator in a moisture-generating device according to an exemplary embodiment of the present invention;

FIG. 3 a block diagram of method steps of the method for operating a moisture-generating device according to an exemplary embodiment of the present invention.

### DETAILED DESCRIPTION

In the figures, identical reference signs denote identical or functionally identical elements.

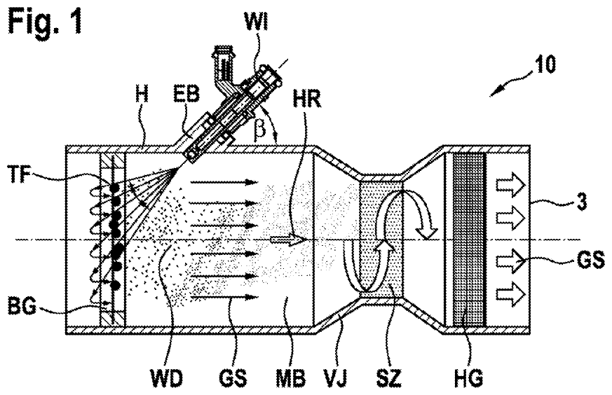

FIG. 1 shows a schematic representation of a moisture-generating device according to an exemplary embodiment of the invention.

The moisture-generating device 10 for generating a moisture-enriched air flow or gas flow comprises a housing H with a main extension direction HR and an outflow region 3, wherein a gas flow or air flow can be generated at least in sections along the main extension direction HR, and with a lateral inlet region EB, which extends at a certain angle to the main extension direction HR, and with a mixing region MB, which extends at least partially along the main extension direction HR in the interior of the housing H; a water injector WI, which is arranged in the lateral inlet region EB and with which atomized water can be introduced into the mixing region MB at the specific angle to the main direction of extension HR, wherein the gas or the air can be mixed with the atomized water in the mixing region MB; a humidifying grid BG, which is arranged in the mixing region MB and towards which the water injector WI is aligned, wherein the humidifying grid BG comprises a plurality of holes and can be wetted with and/or penetrated by the atomized water from the water injector; and a flow generator SZ, which is arranged in the housing H between the mixing region MB and the outflow region 3 and with which the air flow or gas flow with the atomized water can be delivered to the outflow region 3 and generated, wherein the generated air flow or gas flow can be generated by the flow generator SZ and running from the humidifying grid BG and in the direction of the outflow region 3.

The water injector WI can be a water atomizer, by means of which the water can be introduced into the mixing area MB in droplet form TF, wherein the size of the droplets TF can be varied. These droplets can then wet the humidifying grid BG, at least in some areas.

A cylindrical cross-section of the housing H can taper in an area of the flow generator SZ and form a taper VJ of the housing H there. In the main extension direction HR, the tapered area VJ can then widen again after the flow generator SZ, to approximately the same width as the mixing area MB. Such changes in width may produce a gradient (velocity and/or density) in the gas flow or air flow, thereby leading to a change (for example, improvement) in the mixing and evaporation of the water.

The laterally mounted water injector WI can atomize the liquid water supplied to it into droplets and inject it at a certain angle β into the mixing area MB and onto the humidifying grid BG or at least into a gas flow or air flow, for example against it.

The water injector WI can be set up to generate a spray with the smallest possible droplets TF and a sufficiently large angle so that the spray can wet the largest possible areas of the humidifying grid BG. In this case, a pulse of the injected droplets TF can be so large that the spray can penetrate as large a cross-section of the mixing region MB as possible, but also so that the wall of the housing opposite the lateral inlet region EB is not wetted with a water film. The humidifying grid BG can extend perpendicular to the main direction of extension HR and to the walls of the housing H.

The water injector WI can include a swirl injector for this purpose, as this can generate a fine spray of medium impulse with a large angle.

The water injector WI can therefore inject the water against the air flow or gas flow GS. On the way to the humidifying grid BG, the droplets TF can be exposed to an increased relative velocity to the flow GS, which can promote evaporation. However, due to their low inertia, small droplets are carried along by the flow before reaching the humidifying grid BG and evaporate on their way to the flow generator SZ. Large droplets, on the other hand, land on the humidifying grid BG due to their inertia and either evaporate from it as a liquid film or are detached again as smaller droplets by the flow GS passing through the grid BG (reatomization). This process can be accelerated by additional electrical heating of the humidifying grid BG, for example if more new liquid is applied than can be evaporated or reatomized. As a result of the measures described, there is a high probability that the entire liquid will have completely evaporated by the time it reaches the flow generator SZ, or that the air flow or gas flow GS will at least pass it with only a small load of very small residual droplets.

The flow generator SZ can now have the function of swirling the air-water vapor residual droplet mixture GS again. This can increase the relative speed between any residual droplets and the flow, thereby accelerating their evaporation and improving the mixing of vapor and air/gas. In the final step, the swirled (air or gas) flow GS hits the homogenizing grid HG, which both reduces the swirl and uses its kinetic energy to further optimize homogenization through the turbulence generated in it. An inlet opening (intake opening) for the air or gas can be provided in the housing opposite the main direction of extension of the humidifying grid, facing away from the mixing area.

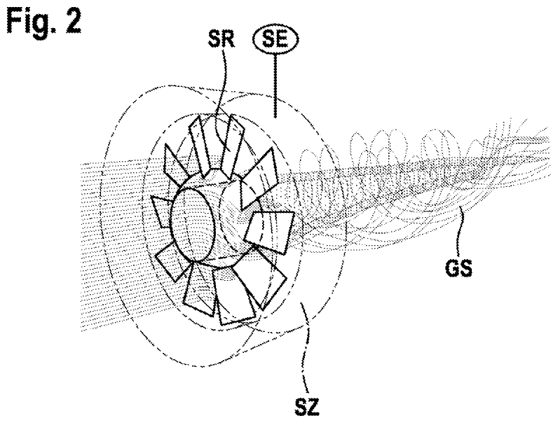

FIG. 2 shows a schematic representation of a flow generator in a moisture-generating device according to an exemplary embodiment of the present invention.

FIG. 2 shows a flow generator SZ as it can be used in the housing shown in FIG. 1. This can be a turbine with a stator and a rotor, on which a blade wheel SR can be rotated and arranged to generate the air flow or gas flow GS (for example, controllable by an electromagnet). The flow generator SZ can be arranged between the mixing area and the outflow area and the air flow or gas flow with the atomized water can be delivered to the outflow area and generated with it, wherein the generated air flow or gas flow can be generated by the flow generator SZ and from the humidifying grid and in the direction of the outflow area. The paddle wheel SR can move the air or gas in the housing of the moisture-generating device and draw it in from and/or through the humidifying grid and push the gas flow or air flow GS to the discharge area.

The moisture-generating device can further comprise a control device SE, which can be connected to the water injector (not shown) and to the flow generator SZ and can be set up to control the flow generator SZ in such a way that a gas flow or air flow can be generated at an outflow area of the mixing area according to a specification for the humidity and or strength of the gas flow or air flow.

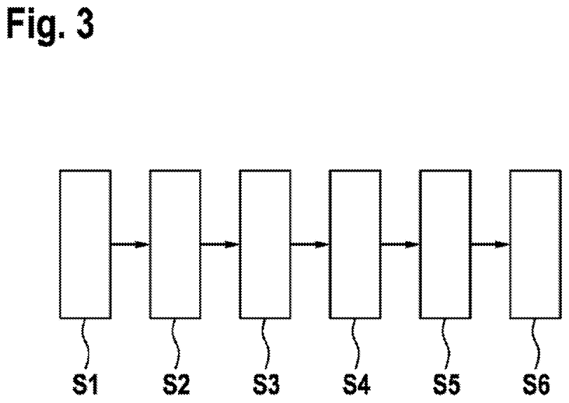

FIG. 3 shows block diagram of method steps of the method for operating a moisture-generating device according to an exemplary embodiment of the present invention.

In the method for operating a moisture-generating device for generating a moisture-enriched air flow or gas flow, the following steps are performed: the step S1 of providing a moisture-generating device according to the invention, the step S2 of introducing the atomized water with the water injector at the predetermined angle against the main direction of extension into the mixing area; the step S3 of wetting and/or penetrating the humidifying grid with the atomized water from the water injector; the step S4 of generating a gas flow or air flow through the flow generator and extending from the humidifying grid and toward the discharge region with the flow generator, and therein the step S5 of mixing the gas flow or air flow with the atomized water and the step S6 of discharging the gas flow or air flow to the discharge region.

Although the present invention has been completely described hereinabove with reference to the preferential exemplary embodiment, it is not limited thereto and can be modified in a variety of ways.

1. A moisture-generating device (10) for generating a moisture-enriched air flow or gas flow (GS), the moisture-generating device (10) comprising:
a housing (H) with a main extension direction (HR) and an outflow region (3), wherein a gas flow or air flow can be generated at least in sections along the main extension direction (HR), and with a lateral inlet region (EB), which extends at a specified angle to the main extension direction (HR), and with a mixing region (MB), which extends at least partially along the main extension direction (HR) in an interior of the housing (H);
a water injector (WI), which is arranged in the lateral inlet region (EB) and with which atomized water can be introduced into the mixing region (MB) at the specified angle against the main direction of extension (HR), wherein the gas or the air can be mixed with the atomized water in the mixing region (MB);
a humidifying grid (BG) which is arranged in the mixing region (MB) and towards which the water injector (WI) is aligned, the humidifying grid (BG) comprising a plurality of holes and being wettable with and/or penetrable by the atomized water from the water injector; and
a flow generator (SZ), which is arranged in the housing (H) between the mixing region (MB) and the outflow region (3) and with which the air flow or gas flow with the atomized water can be delivered to the outflow region (3) and generated, wherein the generated air flow or gas flow can be generated by the flow generator (SZ) and running from the humidifying grid (BG) and in a direction of the outflow region (3).

2. The moisture-generating device (10) according to claim 1, in which the mixing region (MB) is cylindrical and wherein a fuel cell or a supply line of a fuel cell can be connected to the outflow region (3) of the central mixing region (MB).

3. The moisture-generating device (10) according to claim 1, in which the water injector (WI) is a water atomizer, by which water can be introduced into the mixing region (MB) in droplet form, a size of the droplets being variable.

4. The moisture-generating device (10) according to claim 1, wherein the moisture-generating device (10) has a modular design.

5. The moisture-generating device (10) according to claim 1, wherein a cylindrical cross-section of the housing (H) tapers in a region of the flow generator (SZ) and the flow generator (SZ) comprises a stator with a rotor, or a turbine or a blower.

6. The moisture-generating device (10) according to claim 1, further including a control device (SE) connected to the water injector (WI) and to the flow generator (SZ) and configured to control the water injector (WI) and the flow generator (SZ) such that a gas flow or air flow can be generated at an outflow region (3) of the mixing region (MB) according to a specification for a humidity and/or strength of the gas flow or air flow.

7. The moisture-generating device (10) according to claim 1, wherein the humidifying grid (BG) is heatable.

8. A method for operating a moisture-generating device (10) for generating a moisture-enriched air flow or gas flow, comprising the steps of:
providing (S1) a moisture-generating device (10) according to claim 1;
introducing (S2) atomized water with the water injector (WI) at the specified angle against the main direction of expansion (HR) into the mixing area (MB);
wetting (S3) and/or penetrating the humidifying grid (BG) with the atomized water from the water injector (WI);
generating (S4) a gas flow or air flow through the flow generator (SZ) and running from the humidifying grid (BG) and in a direction of the outflow area (3) with the flow generator (SZ) and thereby
mixing (S5) the gas flow or air flow with the atomized water and discharging (S6) the gas flow or air flow to the outflow area (3).

9. The method according to claim 8, in which a predetermined area of the humidifying grid (BG) is wetted with atomized water and the atomized water and/or droplets reliquefied on the humidifying grid (BG) are evaporated on the humidifying grid (BG) by the gas or air flow from the flow generator (SZ) and/or distributed into the mixing area and are swirled and evaporated through the flow generator (SZ).

10. The method according to claim 8, in which the gas flow or air flow is passed through a homogenizing grid (HG) after the flow generator (SZ) and before the outflow region (3) and a gradient of moisture within the gas flow or air flow is homogenized at least in certain regions.

11. The method according to claim 9, in which the gas flow or air flow is passed through a homogenizing grid (HG) after the flow generator (SZ) and before the outflow region (3) and a gradient of moisture within the gas flow or air flow is homogenized at least in certain regions.
